(19) United States
(12) Patent Application Publication
(10) Pub. No.: US 2009/0128339 A1
(43) Pub. Date: May 21, 2009

(54) RFID Chip Holder Device and Tagging Systems Incorporating Same

(76) Inventors: David Mitchell, Vale of Glamorgan (GB); Jonathan Edwin, Vale of Glamorgan (GB)

Correspondence Address: QUARLES & BRADY LLP, 411 E. WISCONSIN AVENUE, SUITE 2040, MILWAUKEE, WI, 53202-4497, US

(21) Appl. No.: 11/914,438

(22) PCT Filed: May 17, 2006
(86) PCT No.: PCT/GB06/01805

§ 371 Date: May 29, 2008

(30) Foreign Application Priority Data
May 17, 2005 (GB) 0510012.8

(51) Int. Cl. G08B 13/14; G09F 3/18

(52) U.S. Cl. 340/572.8

(57) ABSTRACT

There is provided a RFID chip holder device for attachment to an item of portable equipment, the device including: a shell; means for housing a RFID chip disposed within said shell; means for housing a planar insert disposed on an exterior surface of said shell; and means for enabling the holder device to be attached to an item of portable equipment.

This invention relates to RFID chip holder devices for attachment to an item of portable equipment, and to tagging systems incorporating same, with particular reference to safety management applications.

It is standard practice to regularly inspect and maintain items of industrial and constructional equipment for safety purposes. It is known to directly attach a radiofrequency identification (RFID) chip to portable items of equipment. The RFID chip can be used to indicate the location of the portable item as well as to store information relating to inspection and maintenance procedures. However, the attachment of the RFID chip to the item of equipment is less than ideal, the RFID chip being vulnerable to dislodgement and damage. Furthermore, a person encountering the portable item of equipment is unable to determine the safety status of the item unless they are in possession of a suitable RFID reader device.

The present invention, in at least some of its embodiments, overcomes the above-described problems.

According to a first aspect of the invention there is provided a RFID chip holder device for attachment to an item of portable equipment, the device including:

a shell;

means for housing a RFID chip disposed within said shell;

means for housing a planar insert disposed on an exterior surface of said shell; and

means for enabling the holder device to be attached to an item of portable equipment.

The holder device can be used in conjunction with a planar insert which can indicate safety data, inspection data, risk assessment data and the like. The planar insert can also indicate that the item of portable equipment is in a state suitable for use. In this way, safety data and related data pertaining to an item of portable equipment can be visually displayed on a holder attached to the equipment in question. The holder also provides the capability of installing a RFID chip for recording useful information pertaining to the equipment.

Preferably, the shell includes a plurality of coupled shell sub-units, preferably two coupled shell sub-units. Advantageously, the shell sub-units are coupled through snap-fit connections. In preferred embodiments, the snap-fit connections include a plurality of projections formed on a shell sub-unit which are in engagement with a plurality of projection receiving receptacles formed on another shell sub-unit. In particular preferred embodiments, at least one of the plurality of projections is a bore containing projection having a bore extending therethrough, the bore extending to an exterior surface of the shell sub-unit having the bore containing projection formed thereon, and at least one of the plurality of projection receiving receptacles is a bore containing receptacle having a bore extending therethrough, the bore extending to an exterior surface of the shell sub-unit having the bore containing receptacle formed thereon, and wherein the bore containing projection is in engagement with the bore containing receptacle so that a channel is formed through the shell, the channel constituting at least part of the means for enabling the holder device to be attached to an item of portable equipment. Attachment devices such as ties, rings, screws and rivets can be passed through the channel in order to attach the holder device to the item of portable equipment.

Preferably, the shell includes two opposed elongate faces, and is formed from two shell sub-units, each shell sub-unit including one of the elongate faces.

The means for housing a planar insert may include a recess and/or slot located in an exterior surface of the shell. The recess and/or slot may be located on a shell sub-unit. Preferably, the recess and/or slot has indicia indicating that the item of equipment is not to be used. In this way, if the planar insert is not present, the item of portable equipment will be marked as being not for use.

The means for housing a RFID chip may include one or more walls formed on the interior of the shell. Typically, the wall is circular. The wall may be formed on a shell sub-unit.

The means for enabling the holder device to be attached to an item of portable equipment may include one or more apertures. The apertures may be in the form of one or more bores extending through the shell.

According to a second aspect of the invention there is provided a tagging system for an item of portable equipment including a holder device according to the first aspect of the invention and a planar insert housed in the means for housing a planar insert.

The planar insert is typically of a plastics, paper or cardboard material enabling information, such as safety data, inspection data etc to be written on the insert. The tagging system may further include i) a RFID chip housed in the means for housing a RFID chip and/or ii) a handheld board having a recess and/or slot formed therein suitable for housing the planar insert whilst providing a planar support surface for supporting the planar insert thereon. The handheld board is advantageous, enabling the planar insert to be held and supported whilst a person is writing on the insert.

According to a third aspect of the invention there is provided a handheld board having a recess and/or slot formed therein suitable for housing a planar insert whilst providing a planar support surface for supporting the planar insert thereon.

According to a fourth aspect of the invention there is provided a tagged item of portable equipment including an item of portable equipment, and a holder device according to the first aspect of the invention attached thereto.

Typically, the holder device has a planar insert housed in the means for housing a planar insert and/or a RFID chip housed in the means for housing a RFID chip.

The item of portable equipment may be an item of industrial or constructional equipment, such as lifting equipment, small plant equipment, tools, fire hoses, breathing apparatus or a construction element such as a door or cabling.

According to a fifth aspect of the invention there is provided a kit of parts for a tagging system according to the second aspect of the invention.

Embodiments of RFID chip holder devices, tagging systems and handheld boards in accordance with the invention will now be described with reference to the accompanying drawings, in which:

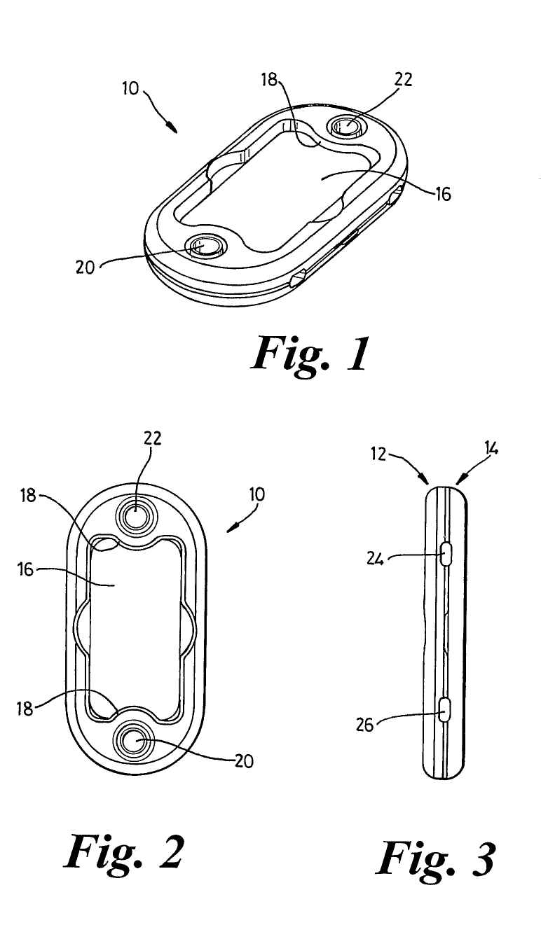

FIG. 1 shows a perspective view of a holder device of the invention;

FIG. 2 shows a plan view of a holder device of the invention;

FIG. 3 shows a side view of a holder device of the invention;

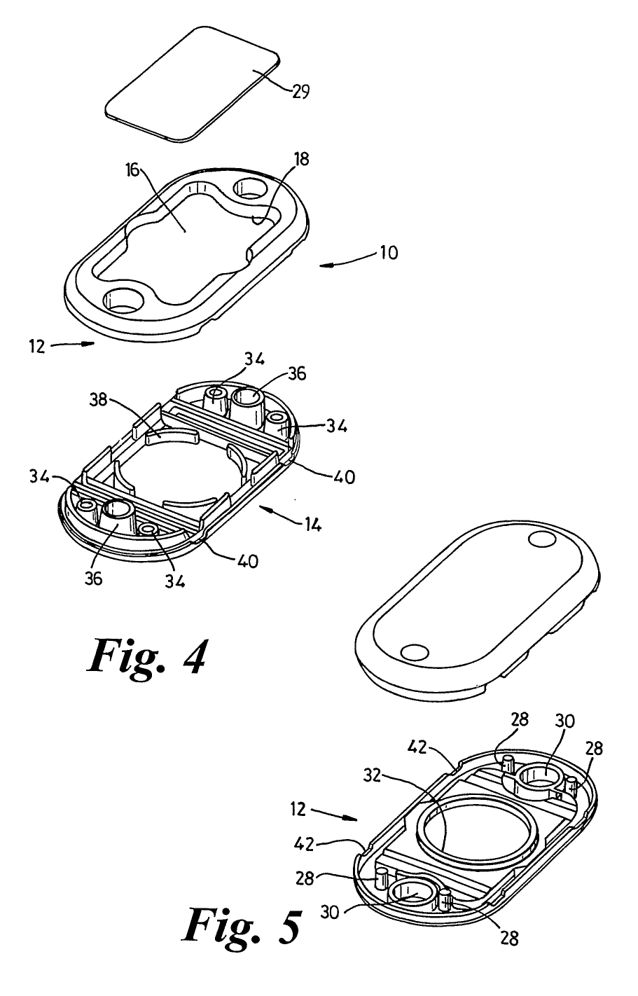

FIG. 4 is an exploded perspective view from above of a holder device of the invention and a planar insert;

FIG. 5 is an exploded perspective view from below of a holder device of the invention;

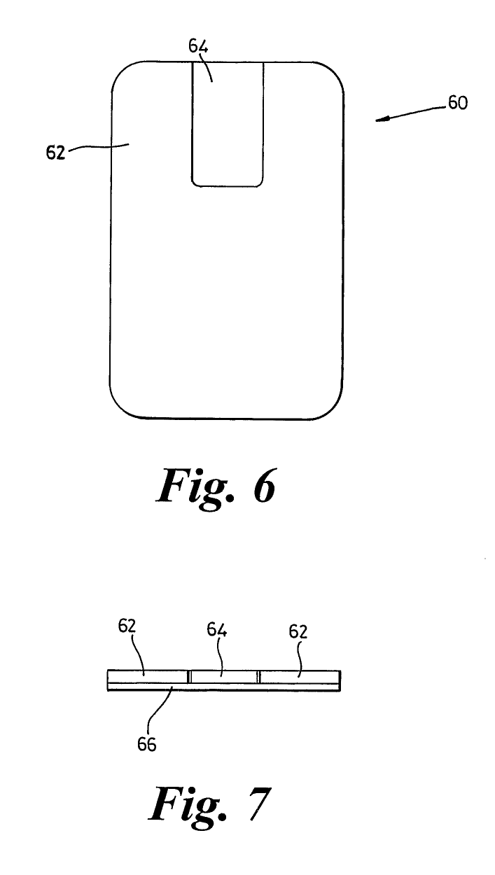

FIG. 6 is a plan view of a handheld board of the invention; and

FIG. 7 is a side view of the top portion of the handheld board of the invention.

FIGS. 1 to 3 depict a RFID chip holder, shown generally at 10, which includes two interlocking sub-structures 12, 14. The interlocked sub-structures 12, 14 form a shell in which can be disposed a RFID chip (not shown). The top sub-structure 12 has a recess 16 formed therein for receiving a tag. Slots 18 are also provided to assist in the location of the tag in the device 10. A pair of bores 20, 22 extend through the holder device 10 from a top surface of the device to a lower surface of the device. A further pair of bores 24, 26 extend transversely across the device 10.

FIGS. 4 and 5 show the device in its unassembled state. Also shown in FIG. 4 is a tag 28 which may be inserted and retained in the recess 16 on the top sub-structure 12. FIG. 5 shows the portion of the top sub-structure 12 that forms part of the interior of the holder device 10 when the device 10 is assembled. The sub-structure 12 includes a plurality of projections 28 and a pair of circular well receptacle structures 30 which define bores extending through to the outer surface of the top sub-structure 12. The top sub-structure 12 further includes a circular wall 32 within which a RFID chip can be located. FIG. 4 shows the region of the bottom sub-structure 14 which forms a part of the interior of the holder device 10 when assembled. This portion of the bottom sub-structure 14 has a plurality of receptacles 34 in the form of tubular members having a central bore suitable to receive a projection 28. The bottom sub-structure 14 also has a pair of spaced apart cylindrical projections 36 which each possess a central bore. The receptacles 34 are disposed so that, when the holder device 10 is assembled, the projections 28 are received in the receptacles 34. Similarly, the projections 36 are disposed so that when the holder device 10 is assembled, the projections 36 are received in the receptacles 30 disposed on the inner face of the upper sub-structure 12. The provision of the bores in the projections 36 and receptacles 30 results in the formation of the two bores 22, 20 which extend through the assembled holder device 10.

The bottom sub-structure 12 further comprises four arc sections 38 disposed on the inner surface of the bottom sub-structure 14. The arc sections 38 are positioned and sized so as to circumferentially engage the circular wall 32 when the holder device 10 is assembled. The bottom sub-structure 14 further comprises a pair of transverse channels 40. The upper sub-structure 12 has a corresponding pair of channels 42 formed therein so that, when the holder device 10 is assembled, the transverse bores 24, 26 are formed.

The holder device of the invention enables safety and maintenance data, such as inspection data, and risk assessment data to be conveniently and visually displayed and stored. A RFID chip can be housed within the holder device 10, and used for storing data of the above-mentioned type. However, it should be noted that the provision of a RFID chip is a matter for the end user, and it is likely that in some instances the holder device will be used without a RFID chip present. The present invention also provides a convenient way of housing a tag 28. The tag 28 contains a visual representation of data such as safety, maintenance and risk assessment data. For example, the tag 28 might display the date that the next test or inspection is due. The tag might have indicia located thereon indicating that the item of equipment that the holder device 10 is attached to is currently permitted to be used, or a system might be implemented in which the mere presence of the tag on the holder device 10 indicates that the item of equipment can be used. Typically, information is displayed on the tag 28 by writing thereon. The tag can be formed from plastics material, paper, cardboard or combinations of these materials. Advantageously, indicia is incorporated in the recess 16 indicating that the item of equipment to which the holder device 10 is attached is not to be used. Preferably, the international prohibition “DO NOT USE” symbol is displayed on the recess 16. In such embodiments, if the equipment fails an inspection, the tag 28 may be removed and handed over to an appointed individual. The holder device 10 then automatically displays indicia indicating that the equipment to which the holder device 10 is attached should not be used.

The sub-units 12, 14 can be conveniently moulded from a plastics material. Representative dimensions of the assembled holder device 10 are length 55 mm, width 26 mm and depth 8 mm. The provision of the bores 20, 22, 24, 26 enables the holder device 10 to be attached to an item of equipment in numerous ways. For examples, cable ties can be passed through any of the bores 20, 22, 24, 26, a ring attachment can be passed through either of the bores 20, 22 or a screw or rivet can be located in either of the bores 20, 22.

FIGS. 6 and 7 show a board 60 for conveniently holding a tag such as the tag 28 shown in FIG. 4. The board 60 is intended to be held in the hand of an individual who is wishing to record data on a tag. The board 60 includes a top surface 62 having a slot 64 formed therein. The slot 64 is sized so that a tag can be located and held therein. The slot 64 has a back wall 66 which supports the tag when a user is recording data on the tag by writing thereon. The back wall 66 and top surface 62 each define planes which are parallel to one another. The depth of the slot 64 is advantageously equal or slightly greater than the thickness of the tag, thereby allowing the tag to be written on conveniently when retained in the board 60. For ease of handling by user, it is preferred that the board 60 is of approximately the same size as a conventional credit card: in a representative example, the board is of dimensions 90×55×2 mm. The board 60 may be a monolithic structure; for example, the board 60 may be formed by moulding from a plastics material. Alternatively, as shown in FIG. 7, the top surface 62 and back wall 66 may be physically discreet components which are bonded or otherwise attached to each other by suitable means, such as by an adhesive.

The holder devices of the invention can be attached to a wide range of industrial or constructional portable equipment, such as lifting equipment, small plant equipment, tools, fire hoses, breathing apparatus, or construction elements such as doors or cabling.

1. A RFID chip holder device for attachment to an item of portable equipment, the device including: a shell; means for housing a RFID chip disposed within said shell; means for housing a planar insert disposed on an exterior surface of said shell; and means for enabling the holder device to be attached to an item of portable equipment.

2. A holder device according to claim 1 in which the shell includes a plurality of coupled shell sub-units, preferably two coupled shell sub-units.

3. A holder device according to claim 2 in which the shell sub-units are coupled through snap-fit connections.

4. A holder device according to claim 3 in which the snap-fit connections include a plurality of projections formed on a shell sub-unit which are in engagement with a plurality of projection receiving receptacles formed on another shell sub-unit.

5. A holder device according to claim 4 in which at least one of the plurality of projections is a bore containing projection having a bore extending therethrough, the bore extending to an exterior surface of the shell sub-unit having the bore containing projection formed thereon, and at least one of the plurality of projection receiving receptacles is a bore containing receptacle having a bore extending therethrough, the bore extending to an exterior surface of the shell sub-unit having the bore containing projection formed thereon, and wherein the bore containing projection is in engagement with the bore containing receptacle so that a channel is formed through the shell, the channel constituting at least part of the means for enabling the holder device to be attached to an item of portable equipment.

6. A holder device according to claim 2 in which the shell includes two opposed elongate faces, and is formed from two shell sub-units, each shell sub-unit including one of the elongate faces.

7. A holder device according to claim 1 in which the means for housing a planar insert includes a recess and/or slot located in an exterior surface of the shell.

8. A holder device according to claim 7 in which the recess and/or slot is located on a shell sub-unit.

9. A holder device according to claim 8 in which the recess and/or slot has indicia indicating that the item of equipment is not to be used.

10. A holder device according to claim 1 in which the means for housing a RFID chip includes one or more walls formed on the interior of the shell.

11. A holder device according to claim 10 in which the wall is circular.

12. A holder device according to claim 10 in which the wall is formed on a shell sub-unit.

13. A holder device according to claim 1 in which the means for enabling the holder device to be attached to an item of portable equipment includes one or more apertures.

14. A holder device according to claim 13 in which the apertures are in the form of one or more bores extending through the shell.

15. A tagging system for an item of portable equipment including a holder device according to claim 1 and a planar insert housed in the means for housing a planar insert.

16. A tagging system according to claim 15 further including a RFID chip housed in the means for housing a RFID chip.

17. A tagging system according to claim 15 further including a handheld board having a recess and/or slot formed therein suitable for housing the planar insert whilst providing a planar support surface for supporting the planar insert thereon.

18. A handheld board having a recess and/or slot formed therein suitable for housing a planar insert whilst providing a planar support surface for supporting the planar insert thereon.

19. A tagged item of portable equipment including an item of portable equipment, and a holder device according to claim 1 attached thereto.

20. An item of portable equipment according to claim 19 in which the holder device has a planar insert housed in the means for housing a planar insert and/or a RFID chip housed in the means for housing a RFID chip.

21. A kit of parts for a tagging system according to claim 15.

22. A holder device, tagging system or handheld board substantially as herein described with reference to the accompanying drawings.
